(19) United States
(12) Patent Application Publication
(10) Pub. No.: US 2024/0416775 A1
(43) Pub. Date: Dec. 19, 2024

(54) ELECTRIC VEHICLE CHARGING SYSTEM AND ARRANGEMENT

(71) Applicant: REEHANA LIMITED, Southend-On-Sea (GB)

(72) Inventor: Haroon SHAIKH, Southend-On-Sea (GB)

(21) Appl. No.: 18/697,496

(22) PCT Filed: Oct. 3, 2022
(86) PCT No.: PCT/GB2022/052497

§ 371 Date: Apr. 1, 2024

(30) Foreign Application Priority Data
Oct. 1, 2021 (GB) 2114123.9

(51) Int. Cl. B60L 53/31; B60L 53/16; E01C 11/22

(52) U.S. Cl. CPC B60L 53/31; B60L 53/16; E01C 11/222

(57) ABSTRACT

The present invention relates to an electric vehicle charging system, an electric vehicle charging system mounted in a kerb and an electric vehicle charging arrangement comprising an electric vehicle charging system and a kerb block.

### TECHNICAL FIELD

The present invention is concerned with electronic vehicles and specifically to electronic vehicle charging arrangements, which are able to provide a compact, easily installed and easily serviceable electronic power delivery system

Electric vehicles are becoming an increasingly popular form of transport. As governments around the world commit to a more environmentally conscious future, the adoption of electric vehicles (EV) is predicted to accelerate. This presents some challenges. Where internal combustion powered vehicles are able to fill their fuel tanks in a matter of minutes, electric vehicle batteries have much slower replenishing rates. Rapid direct current (DC) chargers are addressing this issue, and charging times are falling, but for the majority of drivers and for the benefit of national electricity infrastructure, overnight charging will still form the bulk of recharging activity. In England, it is estimated that a third of households do not have dedicated off-street parking yet there is a lack of provision for on-street charging.

The widespread installation of public charging stations has been hindered by the compromises local authorities face when choosing which of the existing solutions to install. Conventional charging stations are often large, unsightly and obstructive. Furthermore, the desired locations for these charging stations exacerbates present issues. Narrow pavements in urban areas and limited space below ground make it difficult to identify locations (i) where charging stations would not significantly impede foot traffic and (ii) where a sufficient amount of material can be excavated to lay the foundations for a secure installation.

Therefore, there are developments that can be made in this field and advantages that can be obtained from these developments. The inventors of an invention described herein have however created an alternative charging arrangement that has a wide range of previously unavailable advantages as described herein.

### SUMMARY OF THE INVENTION

Aspects of the invention are set out in the accompanying claims.

Viewed from first aspect there is provided an electronic vehicle EV charging system mounted into a kerb. The arrangement of the charging system herein uses space available to such charging systems particularly efficiently by overcoming many of the issues previously identified with the use of such space.

In an example, the system is mounted in a cavity located in the kerb. In an example: the cavity extends through the kerb. Excavating and accessing space below the kerb provides space that is not often utilised to the best extent. The present invention does so.

In an example, the cavity is arranged at an angle to a vertical axis of the kerb. There are considerations when excavating below pavements and roads including the location of various power lines or water pipes or the like. The present invention provides an optimized arrangement when consideration is made of locations of pipes and the like, in light of electrical connections required to provide high voltage (fast) charging.

In an example, the cavity has a circular or elliptical cross section. Bores of such a shape are structurally resilient and can be provided without requirement for specialist equipment. The increases the ease of installation of the present system.

Viewed from another aspect there is provided an electronic vehicle EV charging arrangement, comprising: an EV charging system; and, a kerb block, the EV charging system comprising a casing portion and a housing portion, wherein the casing portion is arranged within and below the kerb block and the housing portion is arranged above the kerb block.

In an example, the casing portion is substantially tubular. Corresponding to a structurally resilient and easily produced bore, a tubular casing improves ease of maintenance and construction.

In an example, the housing portion comprises at least one electrical port for providing electrical charge to an electronic vehicle. The port provides an easily accessible and used arrangement for providing electrical charge to a car. By increasing ease of use, users are more likely to positively engage with the present charging system.

In an example, the housing portion comprises at least one drainage port arranged to remove excess water and/or condensation from the at least one electrical port. This reduces the likelihood that water or liquid will negatively impact delivery of charging service or damage items in the charging system.

In an example, the housing portion comprises a corresponding at least one closeable opening arranged to provide access to the at least one electrical port. The closeable aspect provides protection to the electrical port in light of rain or other similar liquid ingress while the opening provides easy access to a user.

In an example, the housing portion has at least one sloped side. This can provide protection against collisions from e.g. vehicles or pedestrians for both the housing portion and the other colliding element. In turn, this increases the lifetime of the system.

In an example, the housing portion comprises a base arranged towards the bottom of the housing portion and the casing portion comprises a plate arranged to removably connect to the base of the housing portion, wherein the plate is arranged towards the top of the casing portion. The plate provides a strong connection between the housing portion and the casing portion. In turn, this decreases likelihood of ingress of liquid or dirt or the like into the system at the join between the housing portion and casing portion. In turn, this increases the lifetime of the system.

In an example, the plate comprises an abrasive surface on at least one side of the plate, the abrasive surface abutting a surface of the kerb block. The abrasive surface improves the structural integrity of the system and kerb block pair. This allows for kinetic energy from collisions to be shared between both elements thereby increasing the overall structural integrity of both and decreasing the likelihood of damage to either. In effect, the abrasive surface allows for the inertia of both elements to be combined to protect against impact.

In an example, the plate of the casing portion comprises a projection to facilitate removable connection to the base of the housing portion, and the casing portion further comprises a resilient portion located towards the projection. This further improves the robust connection between the casing and the housing. As noted above, this decreases likelihood of ingress of liquid or dirt or the like into the system at the join between the housing portion and casing portion. In turn, this increases the lifetime of the system.

In an example, the housing portion comprises at least one sensor arranged to detect properties of objects within up to 2 meters of the housing portion. Sensing properties can enable additional functions to be provided by the system, such as detecting when a car is parked in a bay adjacent the system but not connected to the charging system or when a car is not parked in an associated bay but the system is in use. This can be provided to owners of other vehicles to inform their parking and charging decisions.

Viewed from yet another aspect there is provided an electronic vehicle EV charging system comprising: a casing portion; a housing portion arranged above the casing portion; a component housing rack for housing electrical components of the EV charging system; wherein the casing portion comprises at least one projection or recess and the component housing rack comprises a corresponding at least one recess or projection for cooperating with the projection or recess in the casing portion for positioning the component housing rack within the casing portion. The component housing rack provides an effective solution to storing electrical components within the system while the recess and projections can assist in the correct alignment of elements within the system during installation and maintenance.

In an example, the casing portion has an opening arranged to receive the component housing rack in the casing portion. Containing the rack in the casing (via insertion through the opening) provides protection to the elements contained on the rack. This in turn increases the lifetime of the device.

In an example, the component housing rack houses at least one power connector towards a bottom end of the component housing rack, the at least one power connector arranged to connect to a corresponding at least one power source. This advantageously takes advantage of the arrangement of cables below a roadway/carriageway/pavement. The arrangement allows power to be easily provided to the system via the power source.

In an example, the at least one power connector is arranged in the component housing rack to be electrically isolated from other electrical components in the component housing rack. Electrical isolation increases the likelihood that certain electrical components do not interfere with other electrical components. In turn, this improves the reliability of the performance of the system. This is of significant importance when the electrical components are handling high voltage power.

In an example, the at least one power connector is arranged to receive a plurality of power supply cables from a power source. Receiving a plurality of power supply cables allows the system to provide charging options of high charging or low charging as best fits the requirement of the user.

In an example, the at least one power connector is arranged to contain a non-conductive liquid or gel. Electrical insulation can be provided by the a non-conductive liquid or a non-conductive gel. This therefore provides, as noted above, an improved reliability of the performance of the system.

In an example, the component housing rack further comprises an earthing bar arranged substantially along a length of the component housing rack. Further electrical protection can be provided by an earthing bar.

In an example, the component housing rack further comprises a central portion located centrally in the rack arranged to receive non-power related electrical components. By centrally locating such items, they are better protected from electrical components handling high voltage power that may impact performance of the non-power related components.

In an example, the system further comprises a plurality of component trays, wherein the component trays are arranged to be removably secured to the component housing rack, and wherein the component trays are arranged to receive electrical components of the EV charging system. The electrical trays allow for compartmentalisation of the components in the system.

These can be grouped by function or voltage loads or the like. It also increases the ease of maintenance and repair of individual elements and of the system as a whole.

In an example, at least one of the plurality of component trays is arranged to provide an environment that is electrically insulated from at least one other of the plurality of component trays. Further electrical protection can be provided by such electrical insulation. Again, this improves the overall performance and reliability of the system.

In an example, the component trays are moveably secured in position in the component housing rack. This increases the ease with which components in said trays can be accessed or installed. This therefore increase the ease of maintenance and repair.

In an example, the charging system is arranged, in use, to be greater in a vertical dimension below ground than above ground. By effectively using space below the ground, the system may be less obtrusive above ground which may reduce the visual impact of the system on the surrounding environment.

In an example, the height above ground in the vertical dimension is up to 70 mm and wherein the height below ground in the vertical dimension is up to 600 mm. Many car bases are above 70 mm from the ground such that unless a car strikes the housing with a wheel, the car may drive over and avoid damaging the housing (and the car). This diminutive surface height is made possible by the effective use of underground space provided by the system.

In an example, the housing portion has at least one sloped side. This can provide protection against collisions from e.g. vehicles or pedestrians for both the housing portion and the other colliding element. In turn, this increases the lifetime of the system.

In an example, the casing portion comprises a plate arranged to removably connect to a base of the housing portion, wherein the plate comprises an abrasive surface on at least one side of the plate. The abrasive surface improves the structural integrity of the system when connected to a kerb. It allows for kinetic energy from collisions to be shared between both elements thereby increasing the overall structural integrity of both and decreasing the likelihood of damage to either.

### BRIEF DESCRIPTION OF THE DRAWINGS

One or more embodiments of the invention will now be described, by way of example only, and with reference to the following figures in which:

FIG. 1 shows a schematic of an electronic charging system according to an example of the present invention;

FIG. 2 shows a schematic of an arrangement of utility apparatus in a footway;

FIG. 3 shows a schematic of an electronic charging system according to an example of the present invention:

FIG. 4 shows a schematic of an electronic charging system according to an example of the present invention:

FIG. 5 shows a schematic of an electronic charging system according to an example of the present invention:

FIG. 6 shows a schematic of a portion of an electronic charging system according to an example of the present invention;

FIG. 7 shows a schematic of a portion of an electronic charging system according to an example of the present invention;

FIG. 8 shows a schematic of a portion of an electronic charging system according to an example of the present invention;

FIG. 9 shows a schematic of a portion of an electronic charging system according to an example of the present invention;

FIG. 10 shows a schematic of a portion of an electronic charging system according to an example of the present invention;

FIG. 11 shows a schematic of a portion of an electronic charging system according to an example of the present invention;

FIG. 12 shows a schematic of a portion of an electronic charging system according to an example of the present invention;

FIG. 13 shows a schematic of a portion of an electronic charging system according to an example of the present invention;

FIG. 14 shows a schematic of a portion of an electronic charging system according to an example of the present invention;

FIG. 15 shows a schematic of a portion of an electronic charging system according to an example of the present invention;

FIG. 18 shows a schematic of a portion of an electronic charging system according to an example of the present invention;

FIG. 17 shows a schematic of a portion of an electronic charging system according to an example of the present invention;

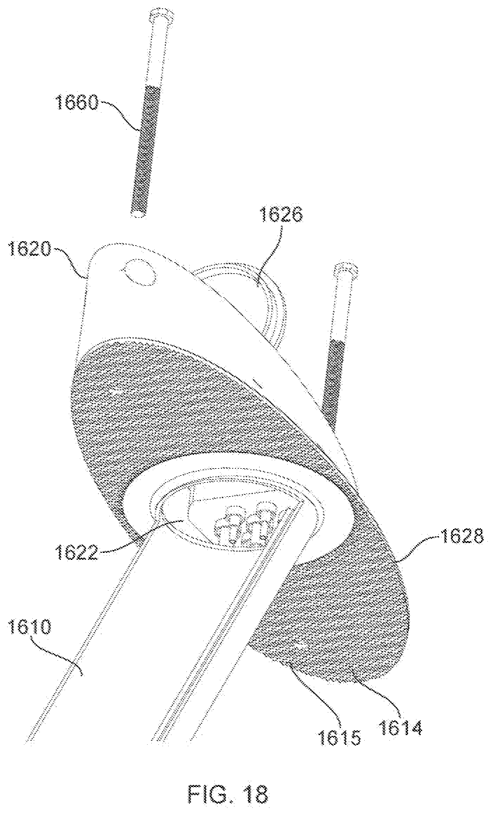

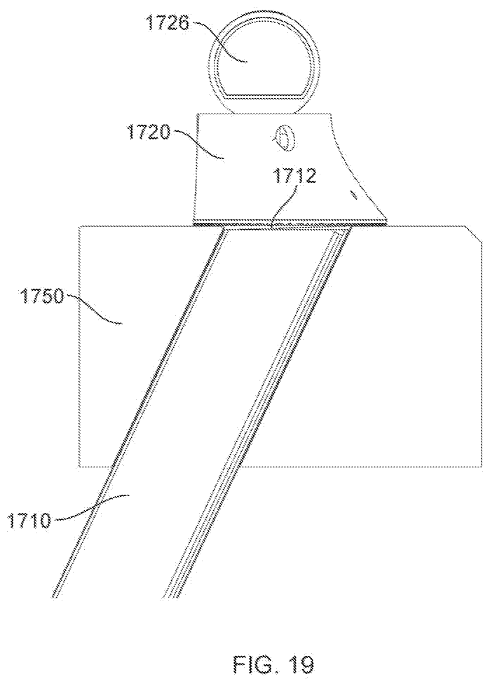

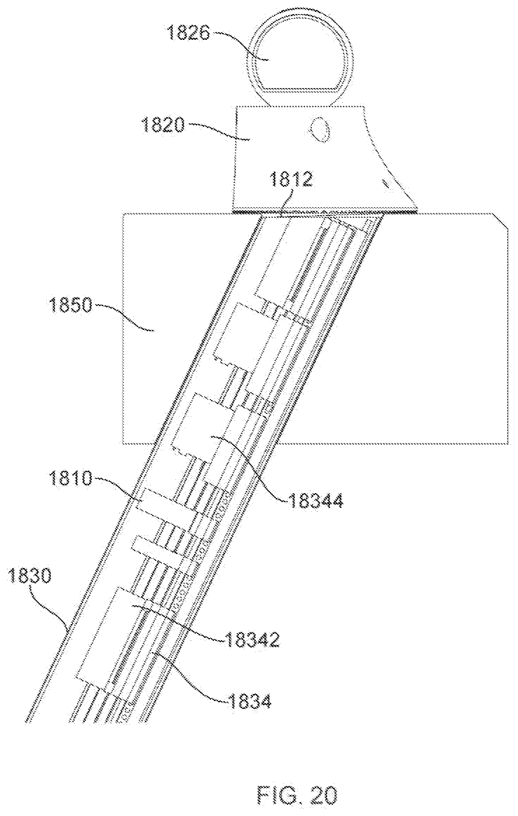

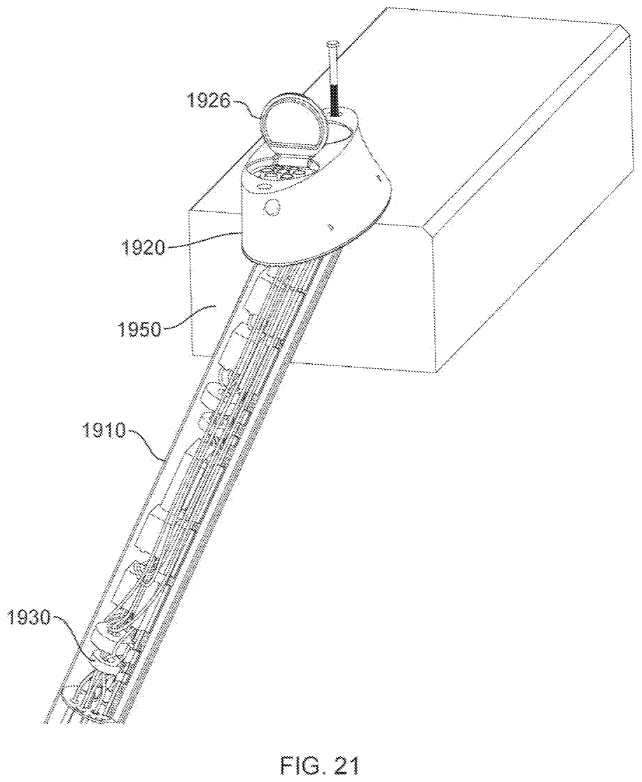

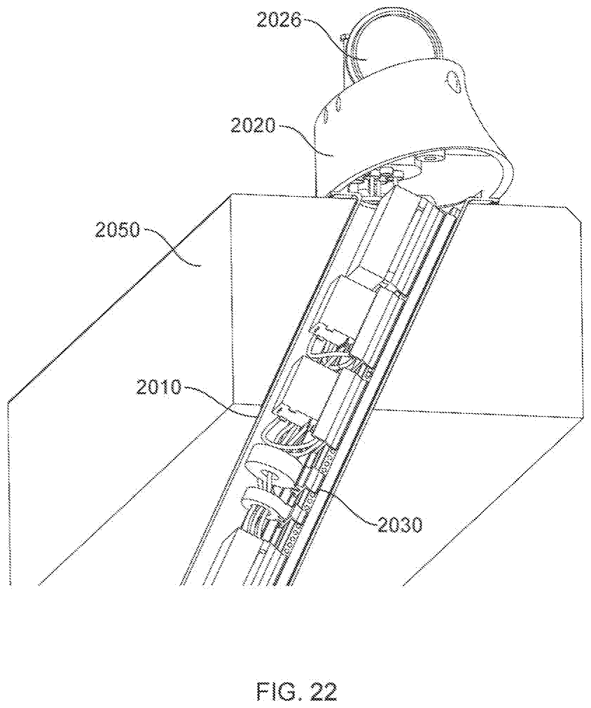

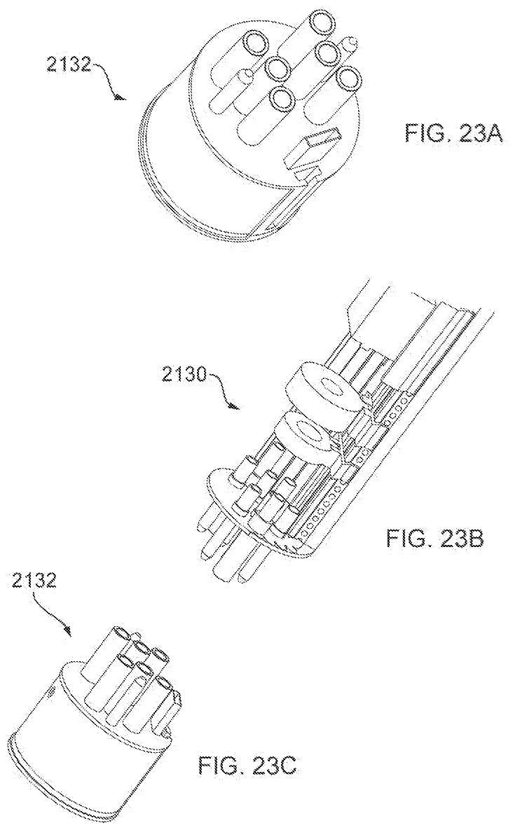

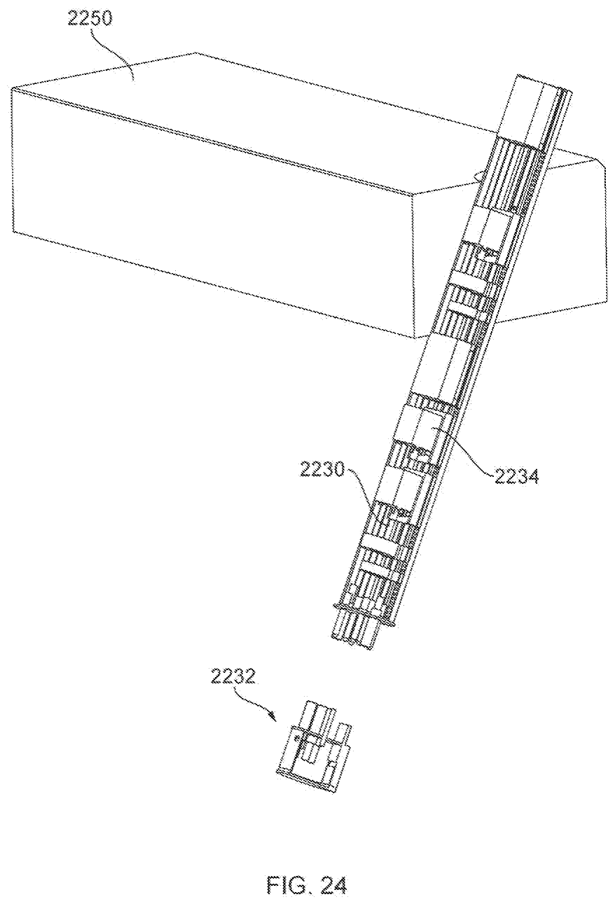

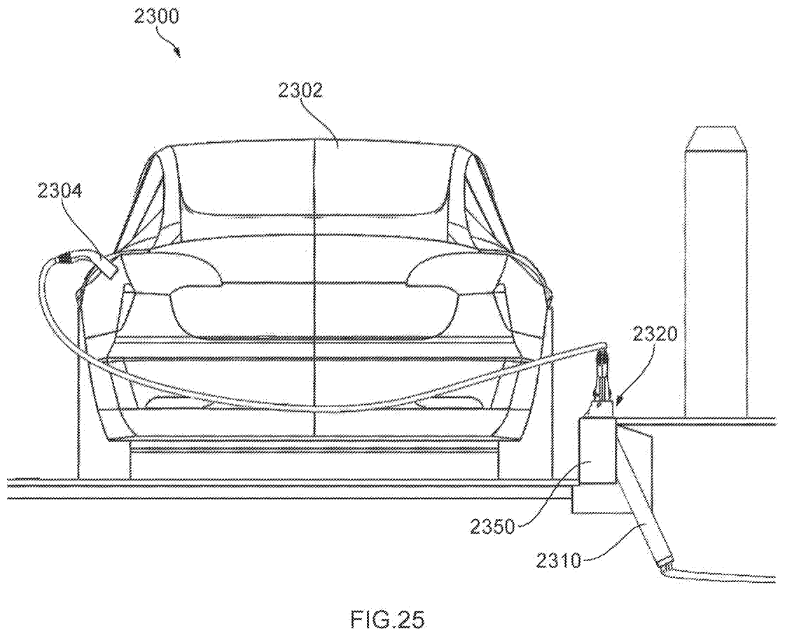

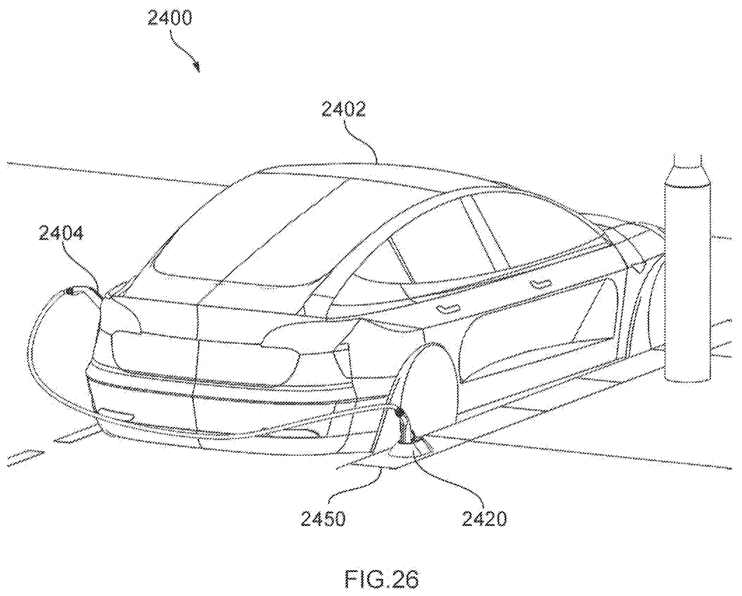

FIG. 18 shows a schematic of a portion of an electronic charging system according to an example of the present invention;

FIG. 19 shows a schematic of a portion of an electronic charging system according to an example of the present invention;

FIG. 20 shows a schematic of a portion of an electronic charging system according to an example of the present invention;

FIG. 21 shows a schematic of a portion of an electronic charging system according to an example of the present invention;

FIG. 22 shows a schematic of a portion of an electronic charging system according to an example of the present invention;

FIGS. 23A, 238 and 23C show a schematic of a portion of an electronic charging system according to an example of the present invention;

FIG. 24 shows a schematic of a portion of an electronic charging system according to an example of the present invention;

FIG. 25 shows a schematic of an electronic charging system in situ according to an example of the present invention; and,

FIG. 26 shows a schematic of an electronic charging system in situ according to an example of the present invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to an electronic charging system for electronic vehicles. A particular electronic charging system involves an over ground portion and a below ground portion. The electronic charging system described herein is space conscious and provides easy access to below-ground components increasing the ease of repair and replacement of these components. This solution is an improvement over present systems and relates to a technology that, overall, reduces the consumption of fossil fuels.

The present invention provides a number of aspects that enable easy access to components of the system that are mainly located below ground. The provision of components below ground increases the difficulty of access but advantageously reduces the impact of the system on the limited spaces above ground, such as on pavements. The present arrangement provides advances in both these important criteria.

In a design for such a charging system, there are also considerations regarding motility of potential users. Where likely users may have reduced motility the present system can be arranged to provide easier access, while in other examples where likely users do not have motility issues the present system does not need to be arranged to provide easier access. As such, there are trade-offs to be considered and the present system can be arranged to be most beneficial in each circumstance.

Many present charging arrangements are located near the intersection of the portion on which cars are intended to travel (road/carriageway/etc.) and the portion on which pedestrians are intended to travel (footway/pavement/sidewalk/etc.). The road asphalt is laid up to the kerb allowing the kerb to perform a function of assisting prevention of deformation of the carriageway. Kerbs (kerbstones, cribstane (Scottish) or curbs (US)) serve a number of purposes including: defining the limits of a carriageway; containing the carriageway so as to prevent “spreading” and loss of structural integrity; providing a barrier between vehicles and pedestrians; providing a physical element to assist preventing vehicles leaving the carriageway. Many kerbs are made these days from pre-cast concrete however natural stone has previously been used.

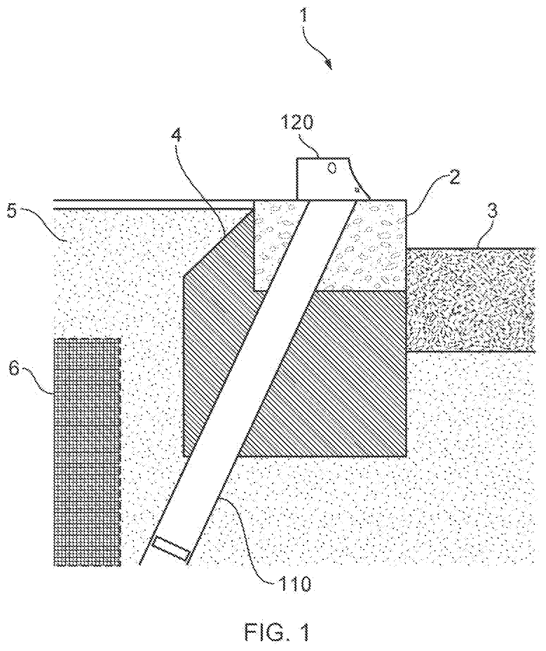

Cables buried beneath the footway/pavement have designated depths dependent on their type (low voltage electrical, communications, water, waste etc.). This typical region of cable laying area is shown in FIG. 1. FIG. 1 shows a kerb, carriage way and charging unit overview 1.

The overview 1 shows a kerb 2 on and in which the casing portion 110 and housing portion 120 of the invention are at least partly located. Also shown in overview 1 is a carriageway 3 which may be made from asphalt or the like and on which vehicles may travel. Below the kerb 2 in the overview 1 is a bed and backing material 4, which itself is located in ground material 5. The typical area for laying cables is shown in cable burying area 6. The overview 1 shows the invention located in the kerb 2.

The present disclosed charging arrangement aims to solve a number of issues related to the installation of electronic vehicle charging infrastructure in on-street locations.

While new footways are designed to have a minimum width of 2 m in the UK, existing pavements are often far narrower. Furthermore, in urban areas where there is often a large amount of infrastructure, the area beneath a pavement is extremely cluttered and often poorly managed. The number of cables stems from the requirement for providing a large populous with electricity, communication, water and the like. The poor management stems from the ad hoc introduction of wires/cables/conduits as required with little effort being made by construction firms to update public registry information.

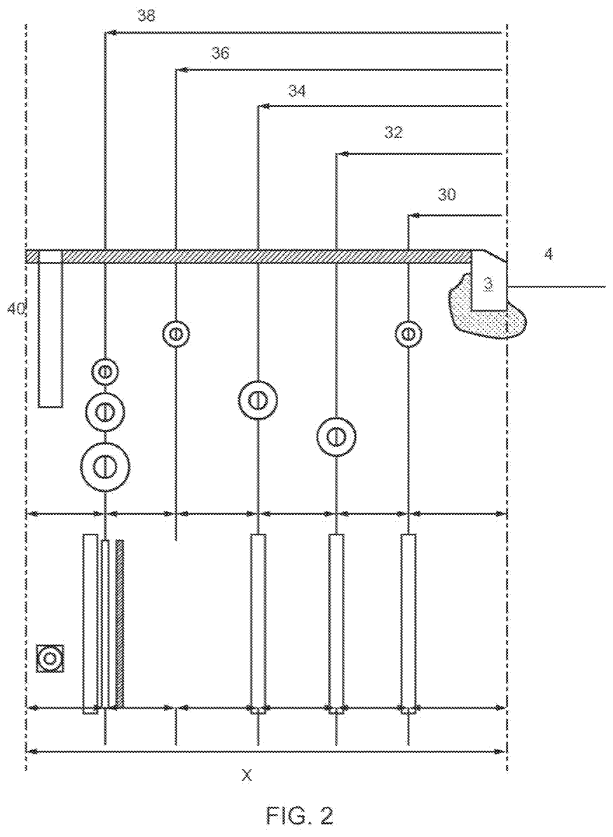

FIG. 2 shows a schematic illustration of recommended positioning of utility apparatus in a 2 metre footway. In particular FIG. 2 shows a carriageway 4 and a kerb 3. FIG. 2 shows the arrangement for different cables or pipes are typically arranged, in vertical depth below, and horizontal distance from, a kerb. While the horizontal distances may not be adhered to, the relative depths shown typically are FIG. 2 shows that there are laid, telecommunications cables, water cables or pipes, gas pipes, cable TV or other further communications cables, and then electrical lines below a kerb 3. Each of these has been indicated by a numeral representing the cabling.

FIG. 2 shows the depth for telecommunications cables 30, water cables or pipes 32, gas pipes 34, cable TV or other further communications cables 38, and then electrical lines 38. In terms of width, each of these may be arranged as follows, the telecoms cables 30 may be around 430 mm from the carriage way, the water cables or pipes 32 may be around 260 mm from the telecoms cables 30, the gas pipes 34 may be around 270 mm from the water cables or pipes 32, the cable TV or other further communications cables 36 may be around 295 mm from the gas pipes 34, the electrical lines 38 may be around 295 mm from the cable TV or other further communications cables 36, the surface box 40 may be around 450 mm from the cable TV or other further communications cables 36.

In terms of depth, the minimum depth is usually around 250 to 300 mm and in the example of high voltage cables, such cables may be buried up to 1 m in depth. As laying cabling or pipes at greater depths involves greater amounts of excavation, it may be that installers look to lay cables and pipes at the upper end of suitable depth ranges. As can be seen in FIG. 2, telecommunications cabling 30, 36 depth is higher in the arrangement than other cabling/pipes. Gas pipes 34 may be arranged around 600 mm in depth. Water cables or pipes 32 may be arranged around 750 mm to around 900 mm in depth. Electrical lines 38 may be arranged around 540 mm in depth for lower voltage lines and up to 1200 mm for higher voltage lines.

As such, these areas under kerbs may be congested with cabling and the cabling arrangements may be relatively complex and difficult to navigate. The present invention utilises this cabling arrangement in a way that simplifies connection to power lines significantly thereby improving installation and maintenance. Modern charging systems do not provide this simplified connection such that connecting to cabling can be time and labour intensive.

The dimensions of the present invention have been selected as it enables sufficient space to house components for a 3 phase twin electrical port system, but also is long enough to project to the electrical lines from which power to the invention may be provided. Furthermore, half a meter depth is thought of in general as a minimum depth for low voltage cabling. As such, the present invention accounts for this subterranean arrangement of cables in a typical arrangement, of course other arrangements may differ from that of FIG. 2.

Current electronic vehicle (EV) charging stations often consist of large cabinets mounted on the pavement a short distance from the kerb. These cabinets require heavy excavation work below the pavement surface so that a concrete bed can be laid that provides the cabinet with solid foundations. Furthermore, the low voltage cables exiting the charging station must be sufficiently deep to be routed to the feeder pillar (a Distribution Network Operator (DNO) maintained cabinet, which houses metering and isolation equipment).

Finding appropriate locations where these excavations can be performed is difficult given the above-described subterranean congestion. Some systems attempt to reduce the above-ground impact of a charging station by retracting a portion of the station into the ground when not in use. These systems often require more substantial foundations and therefore the systems are often more expensive than their stationery counterparts. As such, improvements in this area are available and needed.

The arrangement disclosed herein aims to utilise the space under the kerb that previously, has not been considered usable. During construction work, kerbs are not moved where possible as there is a risk that the integrity of the road will be compromised. As such, this enables installation to avoid the dangers associated with moving a kerb and causing “spreading” of the carriageway—as discussed above.

By boring a hole through the kerb in situ, an angled cavity may be created with one orifice at street level, and the other at a sufficient depth and position for the connection of power cables to other cabling located at that depth. A frame or tube may be inserted into the angled cavity for carrying or containing electrical components.

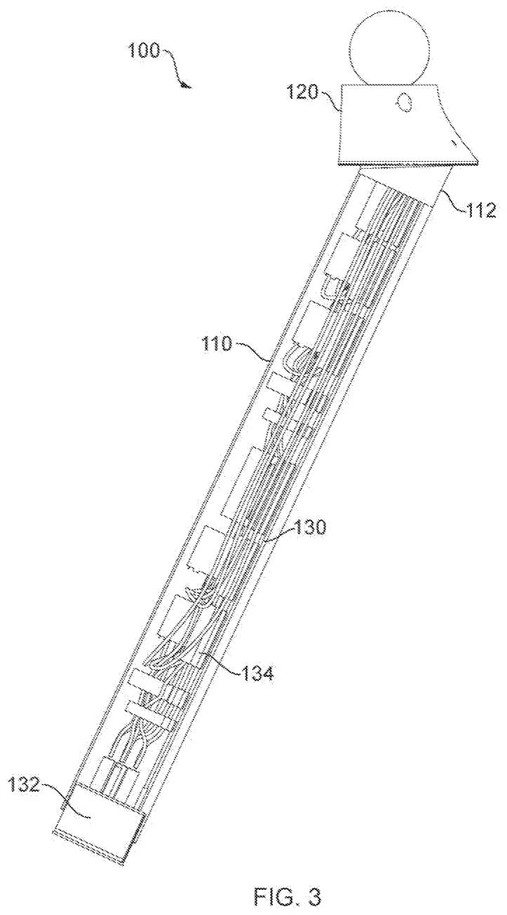

Referring now to FIG. 3, there is shown an electronic vehicle (EV) charging system 100 comprising a casing portion 110. The EV charging system 100 comprises a housing portion 120 arranged above the casing portion 110. The EV charging system 100 comprises a component housing rack 130 for housing components of the EV charging system 100.

The casing portion 110 comprises at least one projection or recess and the component housing rack 130 comprises a corresponding at least one recess or projection for cooperating with the projection or recess in the casing portion 110 for positioning the component housing rack 130 within the casing portion 110.

As used herein, EV charging system may be shortened to “system”, casing portion may be shortened to “casing”, housing portion may be shortened to “housing” and component housing rack shortened to “rack”.

As can be seen from FIG. 3, the housing 120 is located above the casing 110. The housing 120 is located above ground and is the only visible portion of the system 100 when arranged in situ. The casing 110 is located below ground when arranged in situ. The rack 130 can be inserted into the casing 110 and the housing 120 can be arranged above the rack 130 and casing 110.

The projection and recess arrangement of the casing 110 and rack 130 enable the rack to be inserted in a correct orientation. This ensures that assembly of the system 100 is easier and decreases likelihood of damage to components of the system thereby increasing overall lifetime of the system. The casing 110 may have a recess along a length L of the casing 110, the rack 130 may have a projection along a length M of the rack 130 that can be inserted into the recess of the casing 110 which assists in slideably arranging the rack 130 in the casing 110. This arrangement will also secure the rack 130 within the casing 110, by slidably engaging the rack 130 with the casing 110.

During installation, the rack 130 is inserted into the casing 110 via an opening 112 in the casing 110 arranged in the casing 110. The opening 112 may be sized and shaped to correspond to the size and shape of the rack 130. The opening 112 is located at an upper end of the casing 110. The rack 130 is easily inserted and removed through the opening 112 and therefore increases ease of access to the components arranged on the rack 130. Ease of access improves ease of repair and maintenance and therefore in turn increases the lifetime of the system 100.

Also shown in FIG. 3, there is shown a power connector 132. In an example, the rack 130 houses at least one power connector 132 towards a bottom end of the rack 130. The at least one power connector 132 is arranged to connect to a corresponding at least one power source. The cabling for the power sources are arranged to be accessible from the bottom of the rack 130. The power sources may be for example low-voltage mains supply, either single-phase or three-phase. Three-phase voltage may be around 415V line-to-line (240V line-to-neutral), while single phase may be around 240V. The power source may additionally or alternatively be a DC supply (400V or 800V) if power developments lead to, for example, smaller components being developed that can handle the power whilst keeping heat down.

Location of the power connectors 132 towards the bottom of the system 100 means that the connectors 132 are closer to the cables in the ground. In such a way, less connective wire bundles are needed to provide an electrical connection between the components in the system 100 and the power source. As such, this uses fewer resources in forming the system 100. Furthermore, location of the power connector 132 towards the bottom end of the system 100 results in positioning of the rack 130 in the casing 110 being more easy and robust. A user can insert the casing 110 into the rack 130 until the rack 130 clicks into place with the power connector 132. At which point the user is aware and is provided with feedback that the rack 130 is correctly in situ in the casing 110.

The power connector 132 connects to a lower end of casing 110. The connector 132 therefore provides a backstop for the rack 130 when the rack 130 is inserted into the casing 110. The power connector 132 may be fastened into the base of the casing 110 by some retaining means. In an example, the retaining means is a screw or the like. The power connector may provide 1 phase or 3 phase power or the like.

In an example, the at least one power connector 132 is arranged in the casing 110 to be electrically isolated from electrical components in the component housing rack 130. This arrangement assists in decreasing the likelihood of shorting of the system 100. Accordingly, the system 100 has improved safety aspects. Additional safety features may include the rack 130 further comprising an earthing bar arranged substantially along a length M of the rack 130. This assists in preventing electrical malfunction and reduces the likelihood of shocks during handling by a user.

The rack 130 has an outer surface that abuts the casing 110. The rack 130 slidably fits into the casing 110 during construction of the system 100. The rack 130 has a central portion, irrespective or cross sectional shape, though in the examples shown the rack 130 has a circular, ovular or semi-circular cross section. In the central portion, located centrally in the rack 130, non-power related electrical components may be arranged. Isolating these components by locating them centrally in the rack 130 provides an additional level of electrical protection from external power sources located in the ground.

Non-power related electrical components may include communication components, for example PCBs designed to allow the charging system to communicate to various receivers via, for example. Long-fi, to a communication device in the feeder cabinet, or via the telecommunications network to a central server. The various components designed to manipulate the pilot signal (a square wave with variable pulse-width used to communicate with the car), is another example of a component that is not related to high power connection of mains power to the car. Other elements may include sensors and the like as discussed later.

Relatedly, the rack 130 may feature cable guides for high power transmission cables to be located towards an edge of the rack 130. This arrangement provides further protection for the centrally located components.

As shown in FIGS. 3, 4, 13 and 14, the present system may use a plurality of component trays 134, 234, 1134, 1234 located on the rack 130, 230, 1130, 1230 within the casing 110, 210, 1110, 1210. The component trays 134 are arranged to be removably secured to the component housing rack 130. The component trays 134 (also referred to herein as “trays”) are arranged to receive components of the EV charging system 100. In particular, electrical components of the charging system 100 that may need to be removed and replaced can be located in a tray 134 on the rack 130. There may be mating features to enable a secure connection between the trays 134 and the rack 130.

In this way, each component or related groups of components providing a specific function or the like can be grouped on a tray 134. This arrangement will be known to an engineer. If the engineer knows that a specific function or component is faulty, the engineer knows precisely which tray needs reviewing. The engineer can access the system 100 and the casing 110 and slide the rack 130 through the opening 112 of the casing 110 to access the component trays 134. By identifying the relevant tray 134 and then repairing or replacing the faulty element in the tray 134, maintenance is quick and simple. In such a way, maintenance is significantly improved by virtue of ease and time required for successful maintenance.

Each tray 134 may therefore contain electrical components of the system 100. It may be important in use of the system that components from one tray 134 do not impact the performance of components in another tray 134. As such, the environment within each tray 134 may be eclectically insulated from the environments of other trays 134. The power relays in an example may be switching 7 to 14 kW connections whereas the control PCB or control circuitry might consume 12 to 24 W to power the various on-board micro-components.

The trays 134 may be formed from specific materials to enable this. For example, the trays 134 may be made from any of phenolic plastic or similar non-electrically conductive materials. Furthermore, the trays 134 may provide electrical insulation from electrical signals or electrical currents that are in direct connection with the casing 110, rack 130 or tray 134. This again provides greater protection for the components which in turn leads to a more consistent performance and an overall increase lifetime due to reduction of likelihood of damage to the components located in the trays 134.

The trays 134 may be slideably secured on the rack 130. The component trays 134 may be moveably secured in position in the component housing rack 130. In this way, the trays 134 may be moved into position on the housing rack 130 and then secured in position. This may be facilitated by the use of a rail along which the component trays 134 may slide. There may be a series of projections or recesses to secure the trays 134 in position at the correct location on the rack 130. The trays 134 may then be moved from said position by moving over (or the like) the projections or recesses securing the tray 134. The trays 134 may be arranged to run along rails in the casing 110 or on the rack 130 to exit the system 100. This may involve exiting the opening 112 in the casing 110. The trays 134 may be held in position by a resistive element such a spring or a small projection and recess combination. In this way, the component trays 134 are able, with the assistance of some pressure, to slide along the component rack 130, but otherwise are able to stay securely in position on the rack 130.

Referring to the typical arrangements shown in FIGS. 1 and 2, cable laying guidelines and regulations are present however these guidelines are not always adhered to. As such, during installation of other systems, the user is more reliant on these typical arrangements having been adhered to otherwise there is no other way to connect the systems. As the presently disclosed system utilises excavation of volume under a kerb, and therefore provides a great depth within which to locate, and utilise, the relevant cabling. While other systems may engage in a planned installation that is then aborted as the cabling arrangements do not follow those that were expected, the present system is resilient to such an occurrence.

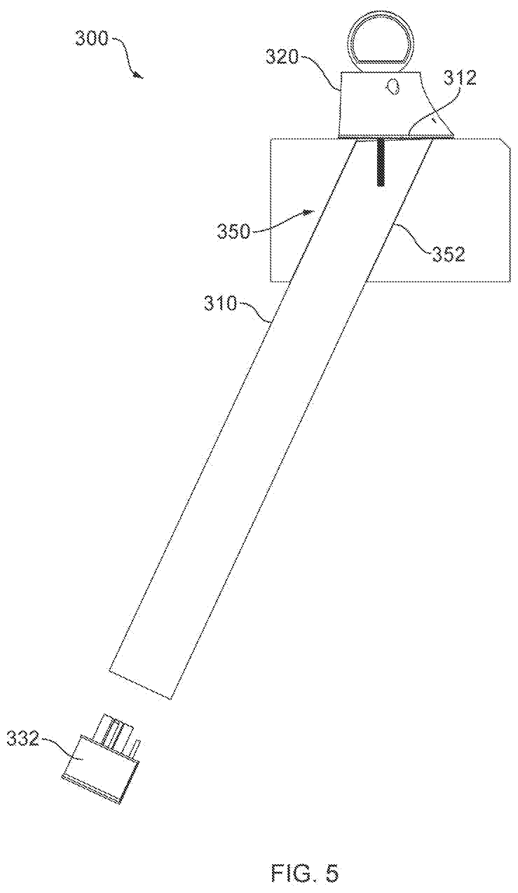

Referring to FIG. 5, there is a shown an electronic vehicle EV charging system 300. The system 300 shown in FIG. 5 shares a number of elements with the system 100 in FIG. 3. Where the same, or a similar, element is shown in FIG. 5, the numeral from FIG. 3 will be used with the number increase by 200. So, for example, the system 100 of FIG. 3, is similar to the system 300 from FIG. 5. For conciseness, not all elements will be discussed, those that are the same may be omitted from discussion. This will be observed for all other Figures where possible, in that system 100 or 300 of FIGS. 3 and 5, may be system 1000 of FIG. 10.

FIG. 5 shows an example of a charging system 300 according to the present invention. The system 300 has a housing 320 located above a casing 310. Also shown is a kerb or kerb block 350. In the example of FIG. 5, there is shown an electronic vehicle EV charging system 300 mounted into a kerb 350. As mentioned above, this is an easier arrangement to construct and provides significant advantages in terms of excavation and space.

In the example of FIG. 5, the system 300 is mounted in a cavity 352 in the kerb 350. The kerb 350 is drilled so as to accommodate the system 300 within it. Pre-forming of the cavity 352 (whether by drilling or otherwise) allows for ease of introduction of the system 300 into the kerb 350 provided the size of the cavity 352 corresponds to the size of the subterranean portions of the system 300.

In the example of FIG. 5, the cavity 352 in the kerb 350 extends through the kerb 350. In the example, the cavity 352 extends fully through the kerb from an upper side of the kerb 350 to a lower side of the kerb 350. The cavity 352, when extending fully through the kerb 350, provides access to underground cabling arrangements that are able to provide power to the system 300. As can be seen, the cavity 352 is arranged at an angle to the vertical axis of the kerb 350. In this way, the insertion of the casing 310 into the subterranean level is easier, the insertion requiring less upward control for an angled entry than a purely vertical entry (0 degrees from the vertical). As such, this angled arrangement also contributes to increasing the ease of insertion and removal of elements into and out of the system 300. In turn, this assists repair and replacement as described above.

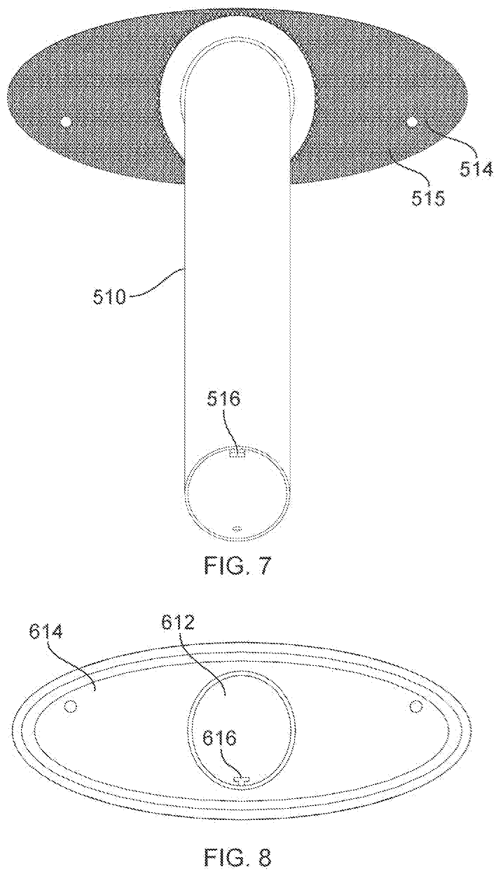

As shown in FIGS. 7, 9, 10, 12, 13, 14, 16 and 24, the subterranean arrangement may be circular in longitudinal cross section. As such, the cavity 352 in the kerb 350 is preferably circular or elliptical in longitudinal cross section. This corresponds to the casing 310 and therefore securely receives the casing 310. Such a circular bore is also the most resistant to stress points in the bore, and so the improved structural strength of the bore therefore provides a more reliable arrangement than other bore shapes. Circular bores are also able to be provided without access to specialist equipment which therefore increases the ease of installation of the present system. The casing 310 may be formed so as to be substantially tubular, corresponding with a tubular bore in the kerb 350. Again, a tubular arrangement is beneficial against stress points building up and therefore is more structurally resilient.

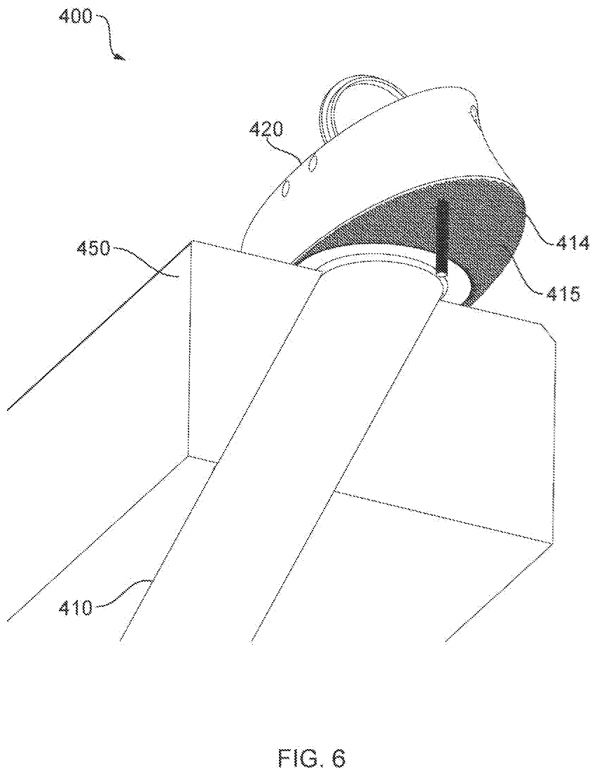

FIGS. 6, 19, 20, 21, 22, 24 illustrate examples of an electronic vehicle charging arrangement comprising an EV charging system and a kerb block. The EV charging system shown in FIG. 19, for example, comprises a casing portion 1710 and a housing portion 1720, wherein the casing portion 1710 is arranged substantially within and below the kerb block 1750 and the housing portion 1720 is arranged substantially above the kerb block 1750. In this arrangement, the kerb 1750 is situated in a position representing the ground level. The casing 1710 is therefore in the main located below ground, when in situ. The housing 1720 is, in the main, located above ground when in situ. The housing 1720 may have a rubberised exterior for added protection against impact from vehicles or the like.

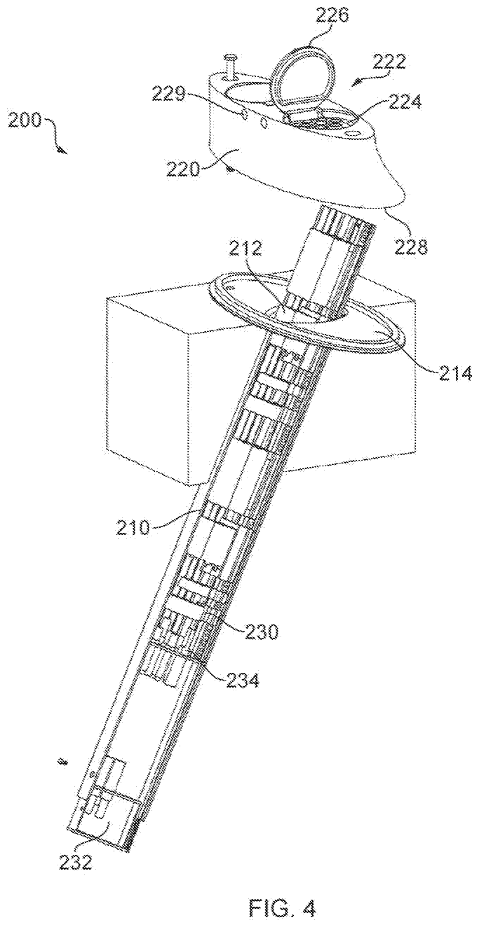

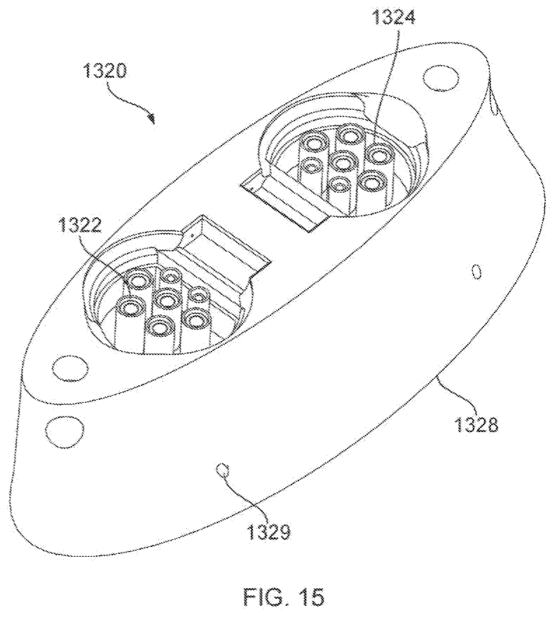

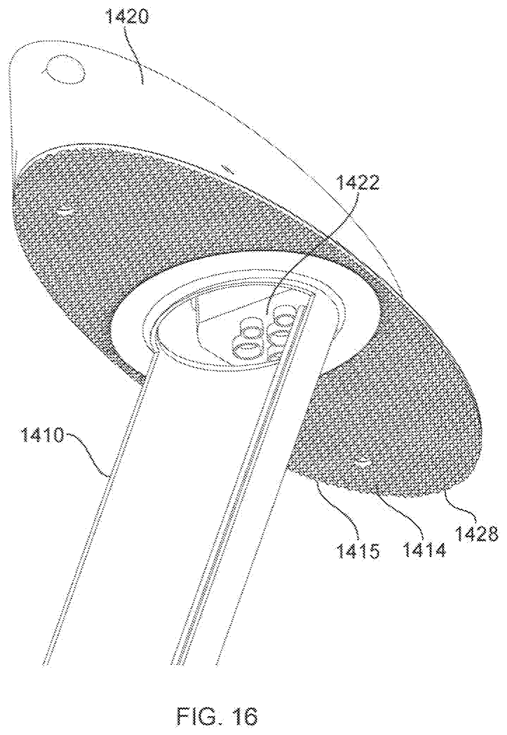

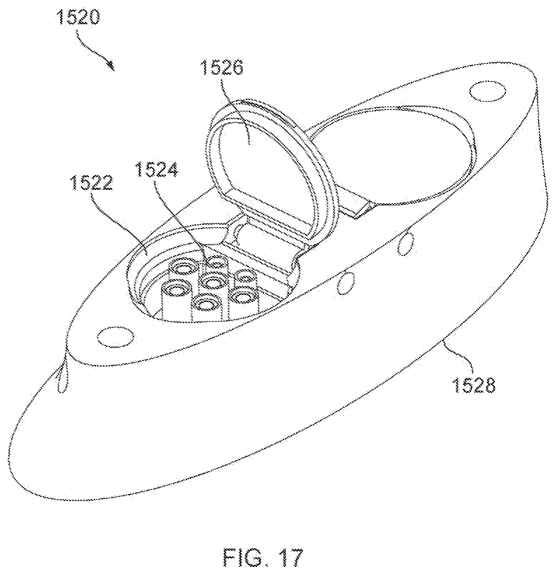

Referring to FIG. 4, the housing portion 220 comprises at least one electrical port 222 for providing charge to an electronic vehicle. The electrical port 222 is the component that users can connect cables to, so as to provide electrical charge to their electronic vehicles. The electrical port 222 may be integral with the housing 220. The electrical port 222 (also referred to herein as “port”) has an opening 224 with a cover 226 that is biased into the closed position (by use of a biased member or the like). In use, the user pulls back the cover 226 to reveal the opening 224 then connects a cable from the charge port on their vehicle to the electrical port 222. The cover 226 and opening 224 may together form a closeable opening. In this way, the electrical port 222 can be, at default position, protected from the environment such as rain or spillages from nearby liquid sources. As shown in FIG. 15, the housing 1320 may have two ports 1322 and therefore two openings 1324 and two covers (not shown in FIG. 15).

The casing 210 of FIG. 4, in an example, may comprise one or more retaining holes 229 for retaining pins that extend through the holds 229 and around which the covers 226 may rotate. This allows a secure rotatable assembly of the covers 226 over the ports 222.

In FIG. 4, the housing portion 220 has a base 228 arranged towards the bottom of the housing 220. The casing portion 210 may comprise a plate 214 arranged to removably connect to the base 228 of the housing portion 220. The plate 214 is arranged towards the top of the casing portion 210. This allows both sections 210, 220 to be easily connected and disconnected. Furthermore, the plate 214 may allow for the two portions 210, 220 to be releaseably engage one other. The undoing of this engagement is made easier by location of the plate 214 which in turn improves access to the electrical components in the casing 210 and therefore improves repair and maintenance of the system 200. The plate 214 may engage the housing portion 220 via a connecting element such as a screw or the like or may fit to the housing portion 220 via push fit or interference fit. In either case, the plate 214 is stable in use but can be removed swiftly and simply to increase ease of removal and maintenance.

Referring to FIG. 6, an under side of the plate 414 is shown. The plate 414 has an abrasive surface 415. The abrasive surface 415 need not be on the under side of the plate 414. FIG. 8 also shows an example of the plate 614. The plate 614 has a projection 616 to facilitate removable connection to the base of the housing portion. The projection 616 can also assist in correct orientation during insertion of elements such as the casing 210 into the bore in the kerb. In particular, FIG. 7 shows a view of casing 510 and the plate 514. The projection 518 is shown and can be understood as enabling correct and accurate insertion and easy removal of elements into the casing 510. The projection 516 may be referred to as a runner, and is designed to allow the rack to be inserted into the casing 510, allowing the rack to slide along the length of the casing 510 but prevents the rack from rotating, as this could lead to misalignment of electrical components. In turn, such misalignment could lead to damage to electrical components. The abrasive surface 515 of the plate 514 can also be seen in FIG. 7.

The system described herein may have at least one sensor for detecting properties of objects in the surrounding area of the system. In particular, the location or proximity of objects in the surrounding area of the system may be used to identify that a car or the like is close to the system and, if too close and therefore likely to cause a collision can emit a sound to inform the nearby object of the location of the system. The sensors may detect size, shape and/or proximity. Such a set up may inform the system as to whether it is a pedestrian or a car that is about to collide with the system. Suitable sensors may include ultrasonic sensor, light sensitive detectors, or the like.

Additional information (properties) may be gathered by the system with the inclusion of relatively cheap sensors such as barometric sensors to detect pressure and weather, noise sensors to detect local sounds and pollution sensors each of which can provide information for use in various capacities. The present system is able to detect when the system is in use, as such the system can know when it has availability for charging or not. An advantage is that the present system is also able to detect, using the ultrasonic sensor as to whether the car parking space that the system is associated with is being used or not, this information can be used alongside whether the charging facility is being used to indicate to potential users whether there is a free parking space with charging facility, or free parking space without charging facility (as the charging is being used by a car not in the associated space by virtue of extension cables or the like), or a charging facility that is free but without an associated parking space. Each of these can be indicated to potential users to inform their parking decisions.

Referring now to FIG. 5, an example of a charging system 300 according to the present invention is shown. In particular, the system 300 has a casing 310 and a housing 320 located with and below and above, respectively, a kerb 350. The kerb 350 has a bore 352 in it to enable the casing 310 to be inserted into the kerb 350. The casing 310 connects to a power connector 332 which enables or provides connection to power cables arranged in the ground (as shown in FIG. 2) to provide power to the system 300. There is an opening 312 shown in FIG. 5 enabling a rack to be inserted into the casing 310.

There is an angle between the bottom of the housing 320 and the casing 310. The angle between the casing 310 and the relatively flat bottom of the housing 320 broadly matches the angle of the bored hole 352 in the kerb 350 such that the casing 310 can be fully inserted into the hole 352 and the bottom of the housing 320 is able to sit flush with the surface of the kerb 350. Kerb surfaces are not always flat, or ideal for a straight surface to be flush with, along the full extent of the surface. The present system accounts for this by ensuring that the connection between the housing 320 and the casing 310 is very secure. This accounts for any misalignment between the bottom of the housing 320 and the kerb 350 as any water, liquid or debris that enters a gap between the housing 320 and the kerb 350 cannot access the casing 310 and therefore the electrical components remain protected throughout the lifetime of the system 300.

FIG. 8 shows a schematic of the plate 614 of the charging system. The plate is designed to fit snugly to the bottom of the housing to assist providing the secure connection between the casing and the housing. The housing is designed to fit snugly over a ridge on the plate 614. This also helps transfer any energy transmitted to the housing onto the sleeve without putting excess strain on any retaining members securing the housing to the kerb or directly to the bored hole.

The projection in the plate 614 may be the same as the projection in the casing once inserted through the opening 812 into the bore hole in the kerb. Alternatively, the plate 614 may have a projection along which the casing slides and the casing may have a projection along which the rack slides. Each projection ensures that the components connecting to the projection (via corresponding recesses or the like) can be easily and reliably inserted and removed from the system. As a portion of the present system projects into a kerb bore, the user may not have a great amount of control over the orientation of elements as they slide into the bore. This system of projections provides a solution to enabling control over the insertion of the components into the bore. This system means that installation does not require specialist tools and therefore increases the ease and cost of installation and maintenance.

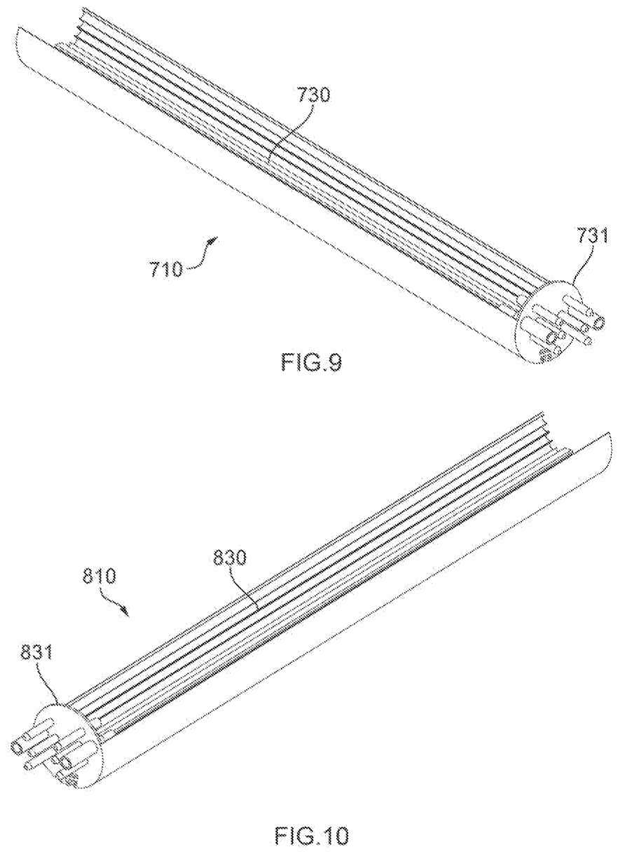

Referring now to FIG. 9, an example of a casing 710 according to the present invention is shown. The casing 710 has a rack 730 located within the casing 710. Also shown in a power connection arrangement 731. The connection arrangement may provide corresponding power connections to the power connector (shown as element 332 in FIG. 5). The rack 730 is open at one end, while the other end has the connection arrangement 731 with a number of connectors. These connectors 731 are electrically isolated from the rack 730 but enable the connection of electric cables on one side, with the other side designed to mate with a supply connector (such as 332 of FIG. 5). A further arrangement for this is shown in FIG. 10, with the numerals for like elements increased from FIG. 9 by 100.

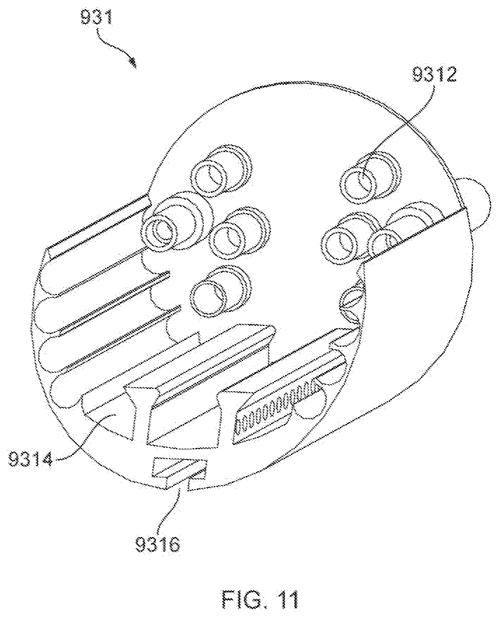

FIG. 11 shows an example of a power connection arrangement 931. The connection arrangement 931 has a port 9312 for connecting to a corresponding port of the supply connector. The connection arrangement 931 also has a series of grooves 9314 and recesses 9318 each arrangement to stabilise internal movement within the system. These allow elements to be carefully guided along other elements or into other elements. In an example, these may improve the reliability of the physical connection between the power connection arrangement 931 and the power supply connector. In turn this improves the reliability of the electrical connection to the charging system overall.

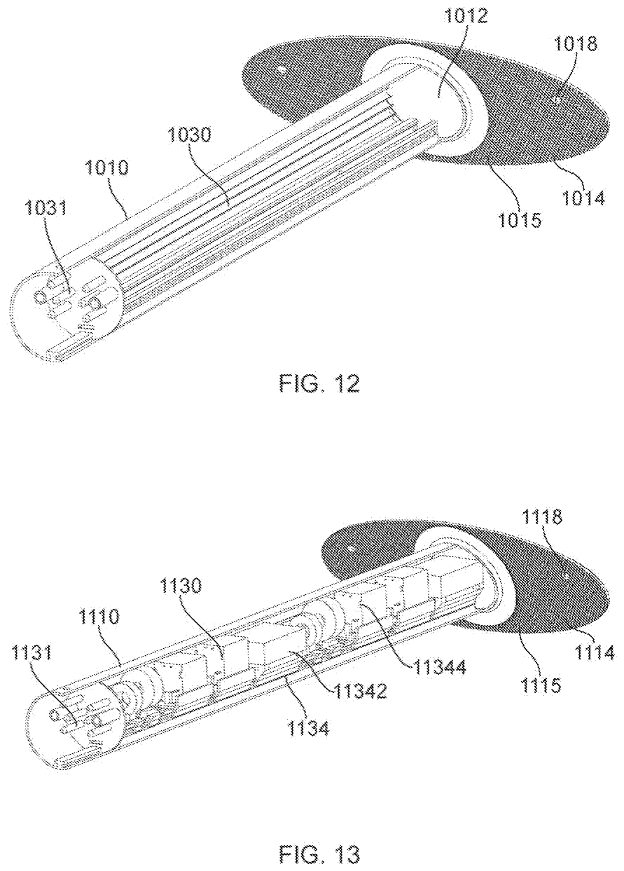

Referring now to FIGS. 12 to 14, examples of a portion of the charging system is shown. FIG. 12 shows an example of the plate 1014 and casing 1010 (located in an opening 1012). The casing 1010 holds a rack 1030 which has been inserted into the casing 1010 via the opening 1012. The power connection arrangement 1031 is located at the lower end of the casing 1010 and is arranged to receive the connections from a power supply. The connectors 1031 protruding from the bottom of the rack 1030 are designed to allow for the connection of high-power electrical supplies—this may be used for fast charging of electronic vehicles. The abrasive surface 1015 and holes for receiving screws 1018 of the plate 1014 are also shown.

FIG. 13 shows an example of a portion of the charging system. The plate 1114 and casing 1110 are shown. The rack 1130 is shown as housing several component trays 1134. One component tray 1134 holds the electronic component 11342, while a different component tray holds the electronic component 11344.

The rack 1130 may feature a rail or the like which allows smaller component trays 1134 to be attached to it. These trays 1134 carry the components 11342, 11344 which may ultimately form a large portion of the electrical hardware of the charging system. The component trays 1134 allow the rack 1130 to accommodate a variety of different component arrangements to suit the charging functionality desired. As discussed above, the component trays 1134 assist in the rapid and easy repair and maintenance of this system.

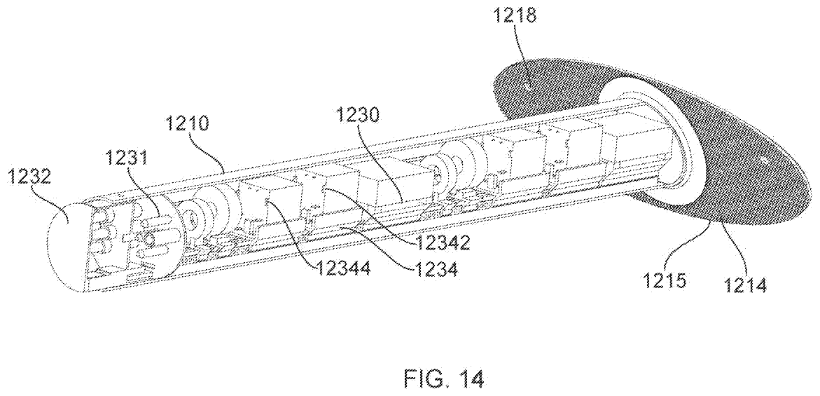

FIG. 14 shows an example of a portion of the charging system. The plate 1214 and casing 1210 are shown. The rack 1230 is shown as housing several component trays 1234. One component tray 1234 holds the electronic component 12342, while a different component tray holds the electronic component 12344.

FIG. 14 also shows (when compared to FIG. 13), the power connection arrangement 1231 adjacent the power supply connector 1232. This connection enables power to be provided to the system, to each component in the trays and ultimately to any vehicle properly connected to the charging system. This may be high voltage power connections to provide fast charging of vehicles or lower voltage power connection for normal charging of vehicles.

Referring to FIG. 15, there is shown an example of a portion of a charging system. The housing portion 1320 is shown. The housing 1320 has two electrical ports 1322 each with an opening 1324 to provide a user access. The housing 1320 has a base 1320 and two drainage ports 1329 to allow liquid from rain or the like to drain from the electrical ports 1322. FIG. 17 shows a similar arrangement to that of FIG. 15 with the reference numerals increased by 200. Housing 1520 is shown with moveable covers 1526 covering the ports 1522. One port is covered as it is in the default closed position while one is open as the cover 1526 has been moved into an open position.

The drainage port(s) 1329 shown in FIG. 15 may be arranged to remove excess water and/or condensation from the electrical portion in the charging system. Removal of liquid is beneficial as this improves the electrical safety of the system. A drainage port may 1329 be sealed by a one-way valve for preventing water that has exited the system from re-entering the system. Condensation can form as the drainage ports 1329 form a connection with the external atmosphere, to be able to release the water into the external environment. Air may cool inside the port 1322 causing micro-condensation, which is beneficially removed. While condensation can occur, a more significant advantage is allowing any water that accumulates in the port 1322 when it is being used in the rain or if the road floods, to be released from the system.

The drainage channels (i.e. from the drainage port to outside the housing) may direct water or other liquid that collects in the electrical ports out to the road (or other external environment). These drainage channels may be fitted with one-way valves to ensure surface water (or other liquid) is not able to enter the port from the roadside, but liquid is forced out when a cable is pushed into the charging port. The drainage ports therefore assist in prevention of damage to the electrical components in the charging port.

Referring to FIG. 18, there is shown an example of a portion of a charging system. The casing portion 1410 and the housing portion 1420 are shown. The electrical port 1422 can be seen through the opening and the base 1428 of the housing 1420 can be seen. The plate 1414 sits adjacent the base 1428 and the abrasive surface 1415 of the plate 1414 can be seen.

Referring to FIG. 18, there is shown an example of a portion of a charging system. FIG. 18 shows the housing portion 1620 and casing portion 1610. FIG. 18 also shows retaining members 1660 that assist in retaining the housing 1620 to the kerb for resilience in the housing. The retaining members 1660 may be screws or the like. The members 1660 assist in securing the housing 1620 (and therefore the charging system) to the kerb for prevention of damage if contacted by a vehicle or the like.

The housing 1620 is secured to the kerb (not shown in FIG. 16) and plate 1614, in an example, via bolts 1660 which are fixed through the housing 1620 and align with holes in the plate 1614 which in turn match drilled holes in the kerb itself. An anchoring plug may be used in the hole drilled into the kerb to ensure each bolt 1660 is able to attach strongly to it. This vertical clamping mounting in combination with the abrasive surface 1615 of the plate 1614 increases the effective transmission of force applied to the housing to the kerb through the plate 1614 and not solely through the bolts 1660 in the kerb. This arrangement reduces the likelihood of fractures and/or broken fixings.

Referring to FIG. 19, there is shown an example of a portion of a charging system. FIG. 19 shows a side on view of the system in a kerb block 1750 with the cover 1726 open to allow a user to access the system to charge a vehicle. FIG. 20 shows a similar example, with reference numerals increased by 100. FIG. 20 also shows component trays 1834 holding components 18342, 18344 in separate trays.

The component trays are designed to grip the central runner, which may be a projection or a recess with the tray having the corresponding part, on the main rack. The trays may also have projections or recesses which correspond to the electrical components to be held. This assists in securely holding the electrical components in place during insertion and when in situ in the system. When constructed, the component rack (with the components mounted inside), forms a module which can be inserted into the casing, sliding into the supply plug at the bottom. The module can just as easily be removed by pulling the rack out of the sleeve. FIGS. 21 and 22 show examples of the casing 1910, 2010 with rack 1930, 2030 with component trays with components having been securely installed. Wiring ensures good electrical connection throughout the system.

Referring to FIGS. 23A, 23B and 23C, there are shown examples of a portion of a charging system. FIG. 23A shows a power supply plug 2132 (or power connector) for connecting to the power connection arrangement. The power supply plug 2132 features a set of pins and sockets designed to fit those extending from the base of the rack. Inside the plug 2132, connectors accept electrical cables from the distribution network which in turn provide respective electrical connections to the pins and sockets. The plug 2132 is designed to provide the network electrical supply connection to the charging system. The network supply cables can be connected to the terminals before the internal volume of the supply plug is filled with a non-conductive resin or gel to ensure the cables remain in place and protected from the environment. The connection portion from the rack is shown in FIG. 238. The supply plug 2132 features the same groove as the rack to allow it to slide along the length of the sleeve. This ensures the supply connector and rack always align in the sleeve.

Referring to FIG. 24, there is shown an example of a portion of a charging system. FIG. 24 shows an arrangement of the rack 2230 in a kerb 2250 being connected to a power connector (supply plug) 2232. When constructed, the plug 2232 is inserted into the bottom of the casing, the component rack 2230 with associated components is inserted into the casing and slots into the plug 2232, and the housing is then fixed to the casing. This fixing may be using bolts, as described above, that run through the top of, and into, the kerb clamping the system to the kerb, forming a watertight seal around the components in the system. Again, this arrangement and construction enables protection of the electrical components against water or general liquid damage. This arrangement also assists in reducing damage from collisions with the housing.

Referring to FIG. 25, FIG. 25 shows a schematic of an electronic charging system in situ according to an example. The charging system 2300 is shown with a housing 2320 above the kerb 2350 and the casing 2310 below the kerb. The system 2300 connects to a charging port 2304 on the electric vehicle 2302. The housing 2320 can be seen to be un-intrusive on the surrounding environment due to its size. The housing 2320 has an asymmetric profile with a sloped side offered to the side that may be at risk of collision from vehicles to protect both the housing and vehicle from damage. The asymmetric profile may be used in a narrower kerb, as it prioritizes decreasing risk of damage from the vehicle side while providing the pedestrian side with a non-sloped vertical surface.

Referring to FIG. 26, FIG. 26 shows a schematic of an electronic charging system in situ according to an example. The charging system 2400 is shown with a housing 2420 above the kerb 2450. The system 2400 connects to a charging port 2404 on the electric vehicle 2402. The housing 2420 can be seen to be un-intrusive on the surrounding environment due to its size. The housing 2420 has a symmetric profile with sloped sides offered to both the side that may be at risk of collision from vehicles and to the side that faces pedestrians. The sloped nature of the housing protects both the housing and vehicle from damage from collisions from a vehicle and presents less of a trip hazard for pedestrians. The sloped surface may also be more gentle to users of wheelchairs or the like, as the wheels may be able to ride over the sloped housing. The symmetric profile may be used in a wider kerb, as the housing is typically wider when both sides are sloped.

The following is a detailed overview of the invention as a whole. As this applies to many of the Figures disclosed herein, specific reference numerals will not be used.

During installation of the present invention, a hole is first bored through the kerb (or kerb block) such that a passageway is created between the upper surface of the kerb and a subterranean area below the kerb (or kerb block) where electrical supply cables can be accessed/routed to. A tube with a flat plate at one end, the flat plate attached at an angle to the tube such that the angle of the bored hole matches that of the tube to the plate, is inserted into the cavity. The tube is referred to herein as the “casing portion”.

The casing portion is sufficiently long to run the entire length of the bored hole. The casing portion may feature a guide on an edge, which may be the lower edge, such that the tube can accept a “mounting rail”, a device which is designed for the constituent operating components to be mounted on. The rail (or “rack” as referred to above) can be easily removed and inserted into the casing portion. The rail can only be inserted in a particular orientation into the casing portion and the components can only be mounted on the rail in a particular orientation by virtue of the relative shapes of the item. The casing portion may have projections or recesses or the like to ensure the rail can be inserted in a particular orientation. The rail may have corresponding recesses or projections to ensure the rail can be inserted in a particular orientation. The components may be inserted into component trays that are sized according to the components. In particular, the trays may be printed via additive manufacturing such that production of the trays is cost effective and quick. In this way, if a new component is required to replace a previous component (resulting for example from an improvement in the hardware), the trays can be remade quickly and cheaply. The trays may be made from materials with desirable electrical and thermal properties according to design.

The mounting rail has a central track that allows components, mounted on trays, to occupy one of a set number of discrete positions. This arrangement allows multiple pieces of hardware to sit on the mounting rail and for the mounting rail to be removed and inserted into the casing portion without components being displaced.

The interaction of the rail and rack provides a solution for holding and electrically linking various components and accordingly provides several advantages. For example, if a component is found to be broken, the broken component can slide off the rack and be replaced with a new component without there having to be significant changes to the overall circuit design. It means that if the new component has slightly different dimensions or connection arrangements to the one it is replacing an entirely new PCB is not needed to accommodate this. The present arrangement provides greater flexibility to the component arrangement and makeup within the casing. This also allows for the components to be mounted on the rack in terms of their assignment to each electrical port rather than in an otherwise prescribed arrangement. Therefore, when new components are to be introduced, there is no need to entirely redesign the component arrangement on the rack. This provides logistical and economic efficiencies.

At the base of the casing portion are a number of connectors, one side of which connects to cables which in turn connect to the various components mounted on their respective trays attached to the mounting rail, the other side of the connectors is designed to slot into a plug which sits in the lower portion of the casing portion.

The plug is designed to allow the electricity supply cables to be connected to the charging system whilst also enabling the mounting rail a mechanism for easy attachment and detachment when removed and inserted into the casing portion. Supply cables have access to the casing portion through the base of the plug and be secured to terminals located inside. The volume inside the plug would most likely be filled with non-conductive resin to form an effective seal. The plug would then be inserted up through the base of the casing portion and secured to a lower portion of the casing portion by means of a retaining screw or other connection means.

The plug is a portion of the system that is not designed to be regularly accessed or manipulated. The plug connects to the mains power supply and so therefore it is preferential if the cables linking to the plug are secured and insulated. Filling the plug with resin assists in the prevention of inbound cables and connections suffering from weathering effects.

The housing portion, which may include connection ports, status indicators and aerials/communication equipment, is designed to be attached to the casing portion using bolts that go through the housing portion, aligned holes in the sleeve plate, and into drilled holes in the kerb. The lower face of the sleeve plate, the element that is in contact with the horizontal face of the kerb, has an abrasive texture such that when the bolts clamp the housing portion to the kerb with the sleeve plate sandwiched in between, the abrasive face of the sleeve plate provides additional integrity to the structure. Indeed, by significantly increasing the friction between the kerb and the system, the abrasive face reduces the danger of collisions by cars into the system. The frictional abrasive face effectively combines the inertia of the system with that of the kerb and therefore assists in prevention of damage to the system during collisions.

In an example, the housing portion may contain a recess on a surface of the inner wall to assist location of the ridge of the sleeve within the housing portion. This ensures that the housing portion has additional contact areas with the sleeve plate by which to transmit kinetic energy if the housing is knocked for any reason. In this way, the system can disperse the energy from being knocked through the components in the system.

In other examples, the housing connection between the housing portion and the casing portion may have a rubber seal, grommet or the like to absorb shock from potential collisions by cars or the like. The casing may also have rubber cushioning located between the casing and the cavity in which the casing is located, again this assists in absorbing shock and therefore provides protection to the casing.

Both these examples assist in transferring some shock from collisions to other parts of the system, rather than dispersing that shock onto the bolts connecting the housing to the casing which are more likely to be damaged than a rubber sealing between the housing and the casing or the casing and the cavity. This rubber sealing, or resilient portion, can be useful for protection of the system against damage from collisions and from weather as the portion may be formed to be completely or relatively watertight.

The housing portion may benefit from an asymmetrical shape. For a given depth, a shallower sloped front on the road-facing surface of the housing portion is more able to withstand a vehicle mounting the kerb and coming into contact with the housing portion. The housing is designed to be sufficiently shallow (<80 mm) so that vehicles are able to park above it without the vehicle snagging. Both these aspects decrease the likelihood of damage to the housing portion and components within the housing portion. As such, this increases the lifetime of the overall system and means that replacement is less frequent, thereby saving the resources required to construct a replacement system. 80 mm being a typical industry lowest ground clearance for motor vehicles, including sports cars, means that by having the housing smaller than 80 mm the housing is protected from the vehicles as much as possible (as the tyres cannot be protected against). While larger housings are possible, there is a clear advantage with the use of 80 mm. A drawback is the volume offered to the components within the housing, however the present system is compactly formed enabling the advantage of low housing height to be provided.

One of the advantages of the present system is that it can be very compact. In particular, the above ground portion can be very compact. In an example, the above ground vertical height may be 50 mm, 55 mm, 60 mm, 65 mm, or up to 70 mm. The below ground vertical height may be 500 mm, 525 mm, 550 mm, 585 mm, or up to 600 mm. The below ground vertical height is dictated by the length of the casing (around 550 to 650 mm and the angle of insertion into the kerb, which may be between 10 to 30 degrees). Clearly this present system provides an advantage of space saving above ground, by utilising a previously unused and undesirable volume: that within the kerb. By reducing the space above ground, there are advantages in the reduction of visual impact on the environment and reduction of likelihood of collision with vehicles or people. The approximate relative volume above and below ground may be between 35% to 50% above ground and, correspondingly, between 65% to 50% below ground.

Different housing portions can be created for a variety of situations, notably in areas where the kerb is sufficiently wide, housing portions can be larger and protected with preventative bars, or the like, to prevent impact damage by cars.

The housing is the above ground portion of the system and is therefore the portion in danger of being contacted by a vehicle. The housing may have a sloped side on the side facing traffic, such that when contacted by a vehicle the vehicles motion is, in the main, transferred upwards rather than sideways into the housing.

The housing may have an asymmetric profile including a sloped side facing the traffic and a flatter side facing the pedestrians (see arrangement shown in FIG. 25). The asymmetric profile may also allow the system to be tailored to kerbs that are not overly wide (for example <120 mm). In such circumstances, a shallower gradient on the face adjacent to the road is effective at dissipating energy in the event that a car contacts the housing—in the manner of a shallow gradient speed bump rather than say a steep gradient wall. From the other side (the pedestrian side), the risk of being damaged is lower. Preferably, the housing can have gently sloping sides surrounding the housing, to prevent cars causing damage. In some space restrictive environments, this may not be possible and a suitable compromise is the non-identical slopes on opposite sides as disclosed herein.

The above-described system has a series of advantages over presently available systems. Firstly, using the kerb as a mounting platform without compromising the integrity or utility of the kerb, allows the charging port to be located extremely close to the car, this arrangement reduces trip hazards from charging cables and ensures minimal impact on the pavement/walkway/sidewalk for pedestrians.

The above-described system also benefits from using the kerb by occupying a volume which would otherwise be unused, present systems are not arranged in kerbs and therefore do not utilise this volume. Such arrangements as described herein reduce the need for expensive subterranean space to be made available for deep foundations, or even deeper cavities into which large pieces of equipment may be mounted.

By effectively utilising the space, the above ground footprint of the system is reduced which in turn reduces the visual impact of the system on the local environment. This is because the smaller size means collisions are inherently less likely and means that any potential damage that can be done is also reduced. A tall charging column, in contrast, requires very strong foundations or significant protection as the force multiplying effect of an impact along way from the base of the tall column has the potential to displace the column relatively easily—this results from the fulcrum-and-lever effect borne from the column being tall and secured only at the ground. Use of a relatively small, above ground housing portion also reduces the susceptibility of the present system to vandalism. Modern system have been reported as being subjected to vandalism that reduces the desirability of use of the system. As such, by improving the below ground efficiency (in terms of using space), the above ground portion can be smaller (as shown in detail above). This leads to reduced area for vandalism above ground and also reduced likelihood of such vandalism.

In one example, the presently disclosed charging system there is no need for expensive or moving parts in contrast to flush mounted pillars that need to rise from the ground. As a result, not only is this example of the present system substantially cheaper but it is also less likely to fail. Again, this provides an improvement over the lifetime of the charging system. Moving parts may be added to provide additional desirable functionality (such as self-opening lids on electrical ports), however this is not required.

The charging system mounting rack enables broken components to be quickly and easily replaced. By housing the circuitry in a compact form where components are arranged in/on trays secured to a track, the mounting rack offers a convenient and effective solution for repairing ‘out of service’ charging stations. By removing the rack, each component tray also slides out of the housing portion. The location of the faulty component is known and therefore this component can be removed and replaced with a new component or removed, fixed and replaced, within a much shorter time than is required for present systems. In this way, maintenance is less of an impact of the local pedestrian and road traffic—which improves local transportation in comparison to the time and space consuming repairs required for modern systems. Indeed, in an example, a faulty rack may be removed and replaced with a fully functioning rack for fastest repair. The engineer may then take the removed rack to a workshop or the like for analysis and identification of the faulty element. In this way, the impact to the charging system is as minimal as possible. The system is offline for only the time it takes to remove the old rack (with at least one faulty component) and insert a new fully-functional one.

The compartmentalisation of the system also enables, for example, the housing to be replaced with a different model should the need arise or be desirable. For example, a new housing with a different array of sensors may be desirable where previously it was not. By removing the housing from the plate, a new housing (with different sensors or charging ports or the like) can be easily connected back to the plate and to the electrical connection beneath. Again, this would improve both the upgrading and repair of faulty housings where required. The present system provides great improvements in the ease of repair and maintenance, all while providing a minimal impact on the service being provided.

All public charging stations will require some level of infrastructure installation. This will often include a feeder pillar, where electricity supply cables are connected to a new meter and then routed into the ground to be channelled to the charging points. The present arrangement provides no need to excavate and dispose of excessive waste material so as to mount the charging hardware, as such installation is much less taxing than for present systems. The net material removed is significantly less with the proposed solution (as only the bores for the kerbs need to be permanently removed) and the installation is significantly simpler and quicker.

The plug arranged towards the lower end of the system can be configured to have full three-phase AC supply at installation so that the mounting rail can contain components capable of taking advantage of this at a later stage. The increases the overall electrical efficiency of the arrangement.

In all the systems disclosed herein, the required space on the pavement for the system as a whole is reduced in comparison to modern systems. This, in turn, reduces the impact on the ease of movement of both pedestrians and vehicles. This makes the present invention easier to install and use and therefore improves the user experience and the likelihood of use by a user. As use of this technology is environmentally conscious, use of the present system contributes to improved atmosphere, climate and life span of both people and the planet.

The advantages provided by these systems are as a result of the arrangement and components in the systems themselves. These arrangements and components are self-contained and therefore the advantages do not negatively affect other areas of any wider pavement-based systems such as the already present cabling. They are, in effect, self-contained advantages without related drawbacks.

The present system provides clear advantages in terms of increased ease of replacement and repair of components. By enabling ease of repair, replacement is required less and therefore the lifetime of each component is also improved, leading to an overall more reliable system than present systems.

In another example of the above system, the system includes an extendable pole which can be mounted into the housing to raise the connection port height. The extendable pole may be used to raise the effective height of the electrical port, such that connecting cables into the ports does not involve bending or lowering to the level of the port (that may be only 70 mm off the ground. In this way, the accessibility of the system is improved for those with movement difficulties, who may not be able to bend to access the low electrical ports when located on the kerb. The pole may be formed of a flexible material to provide resilience to impact. This additional aspect allows an installer or user to improve their experience of the device based on their needs. This aspect can be combined with earlier features to provide the advantages as most needed at the time. The present system therefore is flexible and can be arranged to provide a compromise for any needs of the location or installer or users.

The extension pole/post may slide into the port on the housing and the base of the extension pole may feature a tool that allows the lid on the housing to be opened and the post placed into the port without the need for bending down. The pole includes a mechanical or electrical latching mechanism which mimics the latch operation on the electrical port of the housing. A simple rubber cap/bung may be used to keep dust and material out of the port on the extension pole when it is not being used. The pole can be stored in the car of the user, or the like, when not in use.

Applications for this system therefore may include providing charging for any electronic vehicle.

1. An electronic vehicle EV charging system mounted into a kerb.

2. The EV charging system of claim 1 wherein the system is mounted in a cavity located in the kerb.

3. The EV charging system of claim 2, wherein the cavity extends through the kerb.

4. The EV charging system of claim 2 or 3, wherein the cavity is arranged at an angle to a vertical axis of the kerb.

5. The EV charging system of claims 2 to 4, wherein the cavity has a circular or elliptical cross section.

6. An electronic vehicle EV charging arrangement, comprising:
an EV charging system; and,
a kerb block,
the EV charging system comprising a casing portion and a housing portion, wherein the casing portion is arranged within and below the kerb block and the housing portion is arranged above the kerb block.

7. The EV charging arrangement of claim 6, wherein the casing portion is substantially tubular.

8. The EV charging arrangement of claim 6 or 7, the housing portion comprising at least one electrical port for providing electrical charge to an electronic vehicle.

9. The EV charging arrangement of claim 8, wherein the housing portion comprises at least one drainage port arranged to remove excess water and/or condensation from the at least one electrical port.

10. The EV charging arrangement of claim 8 or 9, the housing portion comprising a corresponding at least one closeable opening arranged to provide access to the at least one electrical port.

11. The EV charging arrangement of any of claims 6 to 10, wherein the housing portion has at least one sloped side.

12. The EV charging arrangement of any of claims 6 to 11, wherein
the housing portion comprises a base arranged towards the bottom of the housing portion and
wherein the casing portion comprises a plate arranged to removably connect to the base of the housing portion, wherein the plate is arranged towards the top of the casing portion.

13. The EV charging arrangement of claim 12, wherein the plate comprises an abrasive surface on at least one side of the plate, the abrasive surface abutting a surface of the kerb block.

14. The EV charging arrangement of claim 12 or 13, wherein the plate of the casing portion comprises a projection to facilitate removable connection to the base of the housing portion, and wherein the casing portion further comprises a resilient portion located towards the projection.

15. The EV charging arrangement of any of claims 6 to 14, wherein the housing portion comprises at least one sensor arranged to detect properties of objects within up to 2 meters of the housing portion.

16. An electronic vehicle EV charging system comprising:
a casing portion;
a housing portion arranged above the casing portion;
a component housing rack for housing electrical components of the EV charging system;
wherein the casing portion comprises at least one projection or recess and the component housing rack comprises a corresponding at least one recess or projection for cooperating with the projection or recess in the casing portion for positioning the component housing rack within the casing portion.

17. The EV charging system of claim 16, wherein the casing portion has an opening arranged to receive the component housing rack in the casing portion.

18. The EV charging system of claim 16 or 17, wherein the component housing rack houses at least one power connector towards a bottom end of the component housing rack, the at least one power connector arranged to connect to a corresponding at least one power source.

19. The EV charging system of claim 18, wherein the at least one power connector is arranged in the component housing rack to be electrically isolated from other electrical components in the component housing rack.

20. The EV charging system of claim 18 or 19, wherein the at least one power connector is arranged to receive a plurality of power supply cables from a power source.

21. The EV charging system of any of claims 18 to 20, wherein the at least one power connector is arranged to contain a non-conductive liquid or gel.

22. The EV charging system of any of claims 16 to 21, wherein the component housing rack further comprises an earthing bar arranged substantially along a length of the component housing rack.

23. The EV charging system of any of claims 16 to 22, wherein the component housing rack further comprises a central portion located centrally in the rack arranged to receive non-power related electrical components.

24. The EV charging system of any of claims 16 to 23, further comprising a plurality of component trays, wherein the component trays are arranged to be removably secured to the component housing rack, and wherein the component trays are arranged to receive electrical components of the EV charging system.

25. The EV charging system of claim 24, wherein at least one of the plurality of component trays is arranged to provide an environment that is electrically insulated from at least one other of the plurality of component trays.

26. The EV charging system of claim 24 or 25, wherein the component trays are moveably secured in position in the component housing rack.

27. The EV charging system of any of claims 18 to 26, wherein the charging system is arranged, in use, to be greater in a vertical dimension below ground than above ground.

28. The EV charging system of claim 27, wherein the height above ground in the vertical dimension is up to 70 mm and wherein the height below ground in the vertical dimension is up to 600 mm.

29. The EV changing system of claims 16 to 28, wherein the housing portion has at least one sloped side.

30. The EV charging system of claims 16 to 29, wherein the casing portion comprises a plate arranged to removably connect to a base of the housing portion, wherein the plate comprises an abrasive surface on at least one side of the plate.
